(19) United States
(12) Patent Application Publication
(10) Pub. No.: US 2017/0357625 A1
(43) Pub. Date: Dec. 14, 2017

(54) EVENT EXTRACTION FROM DOCUMENTS

(71) Applicants: JEFFREY D. CARPENTER, Pasadena, CA (US); Anthony Arroyo, Los Angeles, CA (US); Sean Charles Warnick, Provo, UT (US)

(72) Inventors: JEFFREY D. CARPENTER, Pasadena, CA (US); Anthony Arroyo, Los Angeles, CA (US); Sean Charles Warnick, Provo, UT (US)

(73) Assignee: NORTHROP GRUMMAN SYSTEMS CORPORATION, FALLS CHURCH, VA (US)

(21) Appl. No.: 15/182,393

(22) Filed: Jun. 14, 2016

(51) Int. Cl. G06F 17/22; G06F 17/27; G06F 17/21

(52) U.S. Cl. CPC G06F 17/2264; G06F 17/218; G06F 17/278; G06F 17/2705; G06F 17/274

(57) ABSTRACT

Systems and methods are provided for indexing a document according to identified events. An event-based indexing system includes a source interface configured to receive the document from an associated data source and format the document for processing and an indexer configured to extract event mentions from the document, with a given event mention comprising a verb and at least one of a subject and an object of the verb. A document index is configured to store the extracted event mentions such that a given document from an associated document corpus can be retrieved according to its associated event mentions

### TECHNICAL FIELD

The present invention relates generally to information science, and more particularly to event extraction from documents.

### BACKGROUND

Information science is an interdisciplinary science primarily concerned with the analysis, collection, classification, manipulation, storage, retrieval, dissemination, and understanding of information and knowledge derived from that information. Practitioners within the field study the application and usage of knowledge in organizations, along with the interaction between people, organizations and any existing information systems, with the aim of creating, replacing, improving or understanding information systems. Information science is a broad, interdisciplinary field, incorporating not only aspects of computer science, but often diverse fields such as archival science, cognitive science, commerce, communications, law, library science, museology, management, mathematics, philosophy, public policy, and the social sciences.

### SUMMARY

In accordance with one aspect of the present invention, a system is provided including a data source and an event-based indexing system for indexing a document according to identified events. The event-based indexing system includes a source interface configured to receive the document from the data source and format the document for processing and an indexer configured to extract event mentions from the document, with a given event mention comprising a verb and at least one of a subject and an object of the verb. A document index is configured to store the extracted event mentions such that a given document from an associated document corpus can be retrieved according to its associated event mentions.

In accordance with another aspect of the present invention, a method is provided for indexing a document according to identified events. The document is received from an associated data source. A plurality of event mentions are extracted from the document, with a given event mention comprising a verb and at least one of a subject and an object of the verb. The plurality of event mentions are grouped according at least one of their content, associated context, and an associated time, date, and location to provide at least one event. The extracted event mentions and the at least one event are stored on a non-transitory computer readable medium such that a given document from an associated document corpus can be retrieved according to its associated event mentions and at leave one event.

In accordance with yet another aspect of the present invention, a system is provided including a data source and an event-based indexing system for indexing a document according to identified events. The event-based indexing system includes a source interface configured to receive the document from the data source and format the document for processing and an indexer configured to extract event mentions from the document, with a given event mention comprising a verb and at least one of a subject and an object of the verb. The indexer includes a part of speech tagger configured to assign a part of speech to each word within the document, a grammatical dependency parser configured to identify grammatical relationships between words in a given sentence of the document and create a dependency tree in which one word is the root of the tree and all other syntactic units of the sentence are either directly or indirectly dependent on that word, and a grammar transformation component configured to eliminate semantically irrelevant material from the dependency tree and provide a graph having a same semantic content as the dependency tree. A document index is configured to store the extracted event mentions such that a given document from an associated document corpus can be retrieved according to its associated event mentions.

### BRIEF DESCRIPTION OF THE DRAWINGS

FIG. 1 illustrates one example of a system for indexing a document according to events contained in the document;

FIG. 2 illustrates an implementation of a system incorporating semantic data alignment in accordance with an aspect of the invention;

FIG. 3 illustrates one example the indexing system of FIG. 2;

FIG. 4 illustrates one example of a dependency tree that could be generated by the grammatical dependency parser;

FIG. 5 illustrates a semantic graph generated from the FIG. 4 after a series of grammar-preserving transformations;

FIG. 6 illustrates one example of a method for indexing a document according to identified events; and

FIG. 7 illustrates a schematic block diagram of an exemplary operating environment for a system configured in accordance with an aspect of the invention.

### DETAILED DESCRIPTION

Simple keyword searches perform poorly when applied to a large set of articles. For example, the search results for the phrase “police officer shoots a protester” will produce many irrelevant results because these words are very common. Similarly, contemporary search engines do a poor job of finding related results that do not include the search terms. To provide more relevant search results, semantic search seeks to improve search accuracy by understanding searcher intent and the contextual meaning of terms as they appear in the searchable data space to generate more relevant results. Semantic search systems consider various data points including context of search, location, intent, variation of words, synonyms, generalized and specialized queries, concept matching and natural language queries to provide relevant search results. Unfortunately, semantic search remains an expensive and difficult process, and current applications have only been able to incorporate small elements of semantic search.

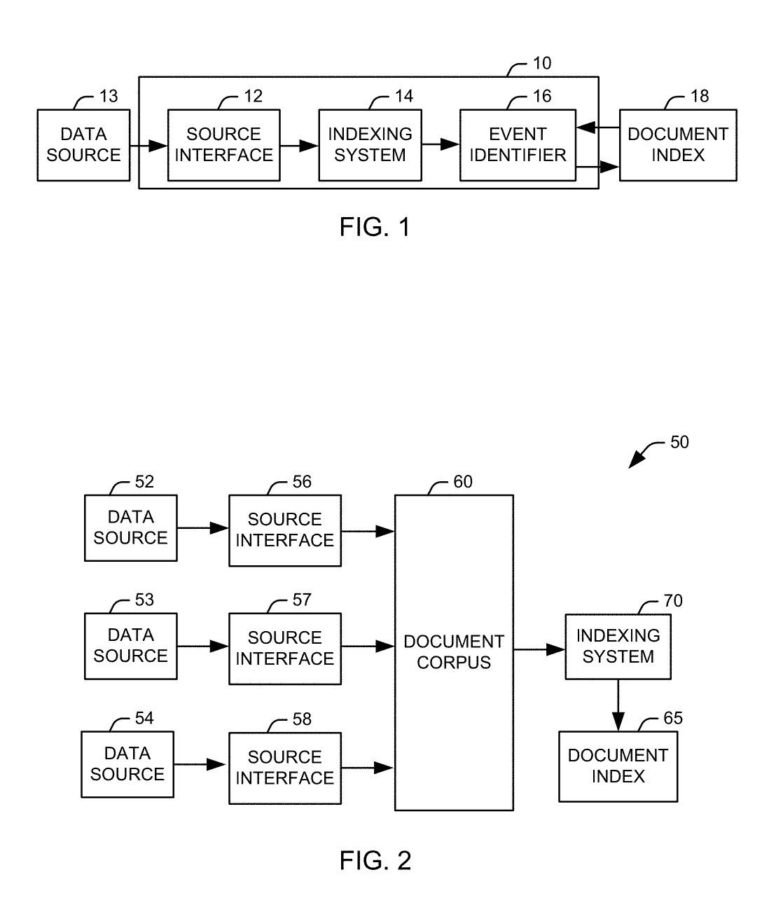

FIG. 1 illustrates one example of an event-based indexing system 10 for extracting events from a document. It will be appreciated that the term “document” is used herein broadly for ease of readability, and that a document should be read to include any data in a form reducible to language, that is symbols with associated meanings and intersymbol structure (syntax), and can include video, audio, structured text, unstructured text, semi-structured text, and modulated electromagnetic radiation. The data included in a document can include source information, such as the date and time the document was generated, the location at which it was generated, and the source of the document, such as a human author or automated system.

It will be appreciated that the system 10 can be implemented as dedicated hardware, such as an application specific integrated circuit, firmware on a dedicated hardware device, or as software or programmable digital logic. In one implementation, the system 10 could be implemented as a content addressable memory (CAM) in a field programmable gate array (FPGA) or similar device. Alternatively, the system could be implemented as software instructions and executed by a general purpose processor.

In the present example, the system 10 includes a source interface 12 configured to receive documents from one or more data sources 13. For example, a data record can include all of portions of any of a television or radio broadcast, a raw radio signal, a voicemail, an e-mail, logged chat room activity, a web page, a database record, or similar data. The source interface 12 formats the received documents into a form appropriate for processing, for example, reducing them to digital text, and provides them to an indexing system 14.

The indexing system 14 extracts event mentions from sentences within the received digital text, with a given event mention defined as a verb and at least one of a subject and an object of the verb. It will be appreciated that a “verb” can include multiple words, for example, where the verb is of one of the perfect tenses in English. To this end, the indexing system 14 labels the part of speech of each word on the page and parses the document to determine grammatical relationships between words. A series of grammar transformations, selected to replace certain grammatical structures by more convenient structures with the same semantic content, is then applied to transform the parsed document into a form resembling a semantic graph. This graph is then searched for each of a defined set of patterns to identify event mentions. The most common of these patterns is a subject/active verb/object triad of words or phrases, and in practice, a document can be successful indexed with no more than twenty or so such patterns once the appropriate grammar transformations have been applied.

The identified event mentions are then provided to an event identifier 16 configured to group the event mentions from that document, and in one implementation, other documents, to create more detailed and complex events. For example, characteristics of the event mentions, such as their content, context, and associated time, date, and location, determined from the text or from metadata extracted from the source document, can be used to group a set of event mentions across documents into events. Further, the number of event mentions associated with a given event can be used as an indication of the seriousness or importance of the event. The identified events can then be stored as a document index 18 to allow the documents associated with the event to be searched or accessed by automated system according to the events and event mentions contained therein.

It will be appreciated that the illustrated system 10 is simplified for the purpose of illustration, and that a practical implementation of a system in accordance with an aspect of the present invention would likely be distributed across multiple, spatially separated, computer systems. For example, the source interface 12 can comprise multiple interfaces across various data sources. Similarly, it is likely that various end users of the system, either human or automated, might access the system remotely, for example, via a network connection, and the indexing system 14 and event identifier 16 may include one or more indexers and/or event identifiers local to each end user representing subjects of interest to the end user as well as multiple groups to which the user belongs.

FIG. 2 illustrates an implementation of a system 50 incorporating semantic data alignment in accordance with an aspect of the invention. The system 50 comprises a plurality of data sources 52-54 that provide data records for analysis. For example, the data sources 52-54 can include any of television or radio broadcasts, voicemails, an e-mail server, an Internet connection, raw radio, microwave, or optical signals, a relational database, or any other information source. The extracted data records are provided to respective source interfaces 56-58 configured to format the extracted data records as digital text for analysis. A given source interface 56-58 can utilize various functional components for this purpose, depending on its associated data source, including any of optical character recognition, speech recognition, and a structured query language (SQL) builder for querying an associated database. It will also be appreciated that a given indexer can be local to its associated data source, local to a document corpus 60, or at a location other than its associated data source and the document corpus.

In the illustrated implementation, each source interface 56-58 extracts data from incoming data records as digital text and provides the data to a document corpus 60. A document index 65, representing the document corpus, is then generated by an indexing system 70. It will be appreciated that either or both of the document corpus 60 and the indexing system 70 can be distributed across multiple computer systems, and, in one implementation, each source interface 56-58 can have a local hardware or software component performing the function of one or both of these components.

In one implementation, the document index 65 user can search the index for specific events. A search request can be inputted, for example, as a subject-verb-object combination, such as “police shoot protestors.” When entering the query, the user is presented with a dropdown list of potential meanings, including, where applicable, defined named entities. This dropdown list allows the user to provide accurate semantic meaning to the search system at the outset. For example, if a user enters the word police, the drop down list might include Police (Band) and Police (officer). Once the user submits their query it is first analyzed to find synonyms. In one example, the WordNet database from Princeton, but it will be appreciated that any similar dictionary can be used. These synonyms are used to perform fuzzy matching upon retrieval. The system also performs a semantic time extraction which converts relative dates, such as yesterday, into absolute dates. The refined query is then used to search the index 65 based on the event mentions, events, and narratives contained in the index, and the user is presented with the relevant results.

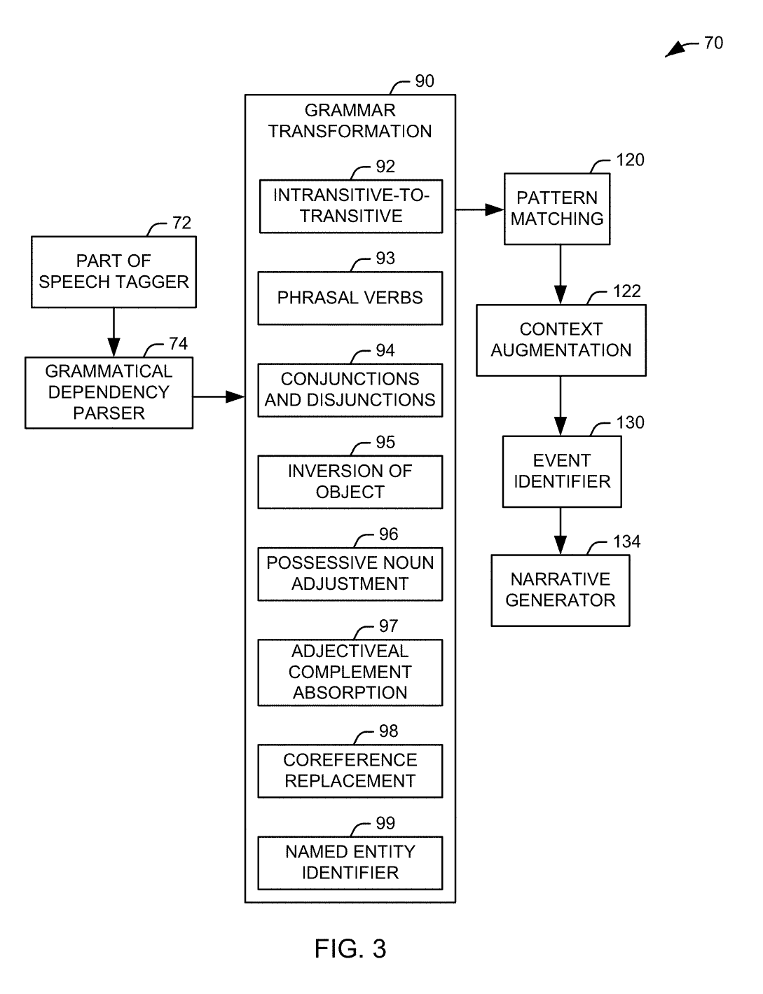

FIG. 3 illustrates one example of the indexing system 70 of FIG. 2 in detail. The indexing system includes a part-of-speech (POS) tagger 72 on the content of each page. The POS tagger 72 is configured to review a given text and assign parts of speech, such as a noun, verb, or adjective, to each word. In the illustrated implementation, the POS Tagger 72 is configured to identify about thirty different parts of speech, as well as non-word tokens, such as punctuation. The tagged document is then provided to a grammatical dependency parser 74. The grammatical dependency parser 74 identifies the grammatical relationships between words and creates a dependency tree in which one word, usually a verb, is the root of the tree, and all other syntactic units, consisting of one or more words or other tokens, are either directly or indirectly dependent on that word.

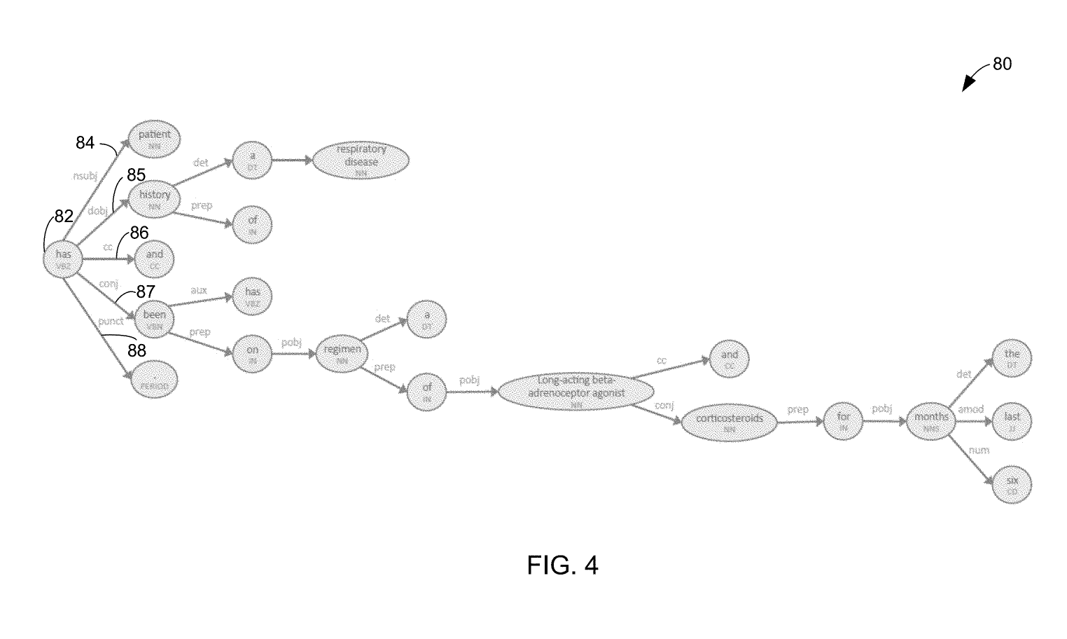

FIG. 4 illustrates one example of a dependency tree 80 that could be generated by the grammatical dependency parser 74. Specifically, the dependency tree 80 represents the sentence “The patient has a history of respiratory disease and has been on a regimen of LABA and corticosteroids for the last six months.” A root node 82 of the tree represents the verb “has” and five main branches 84-88 of the tree represent words and phrases associated with the verb. A first branch 84 represents the subject “patient”, a second branch 85 represents a phrase that is the object of the verb, a third branch 86 is a conjunction linking two predicates, a fourth branch 87 represents the second predicate, and the fifth branch 88 represents the punctuation of the sentence. It will be appreciated that this dependency tree is very complex, and that it would be difficult to extract the fact that the patient has been on corticosteroids from this dependency tree in its current form.

The dependency tree is then provided to a grammar transformation component 90 configured to convert the dependency tree into a form resembling a semantic graph having the same semantic content. Each transformation 92-99, in general terms, can be said to discard or move aside semantically irrelevant material to make it easier to conduct pattern matching. In the illustrated implementation, eight transformations that are performed, although it will be appreciated that additional or different transformations may be utilized.

An intransitive-to-transitive verb conversion 92 transforms certain constructions involving an intransitive verb, one or more prepositions, and a prepositional object into a compound transitive verb with a direct object. A phrasal verbs conversion 93 transforms a verb and particle or a verb and proposition into a verb. A conjunctions and disjunctions expansion 94 expands combined phrases into multiple distinct phrases. An inversion of object quantifier phrases component 95 utilizes hypernym relationships from a lexical database to identify applicable quantifier phrases and invert them to make their objects depend on the governing verbs. A possessive noun adjustment 96 replaces the subject or object dependency relationship to the base of a possessive noun with a special “possessive” version to prevent the base noun (without the final “5”) from being misidentified as a subject or object. An adjectival complement absorption 97 coalesces intransitive verbs and simple adjectival complements into compound verbs. A coreference replacement 98 replaces pronouns and other coreference mentions with explicit referents. In one implementation, this is done using the Stanford Coreference Resolution System, although any similar system could be used. This implementation further uses a number of rule-based substitutions made in the case of structures (e.g., involving relative clauses) that are not handled by the Stanford Coreference Resolution System. Finally, a named entity identifier 99 identifies named entities (e.g., proper nouns) from an associated database and tags them.

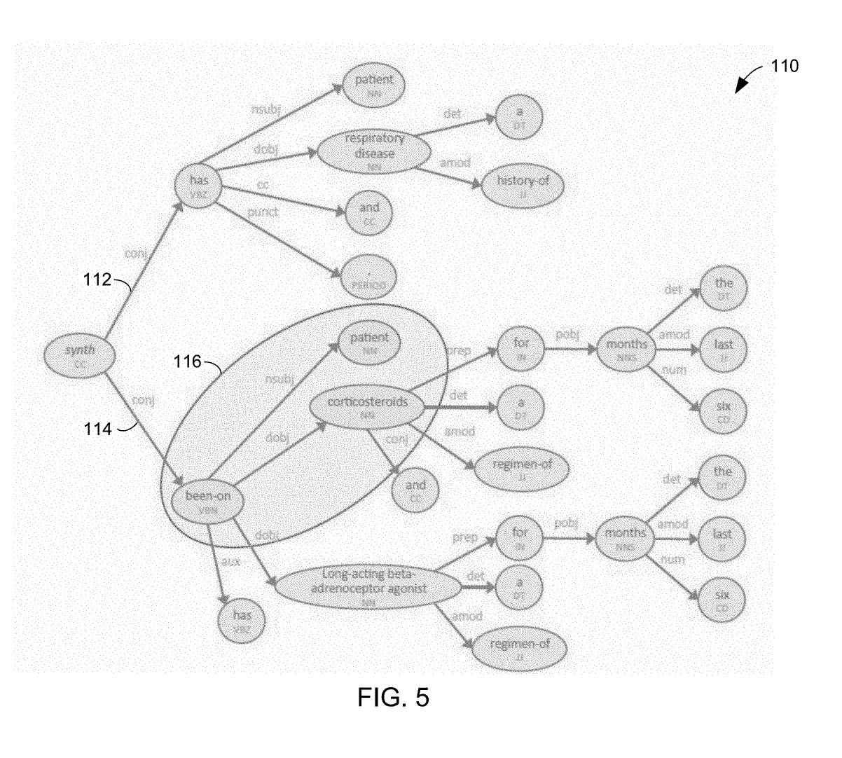

FIG. 5 illustrates a semantic graph 110 generated from FIG. 4 after the grammar-preserving transformations. As can be seen, the graph has two main branches 112 and 114, each representing a predicate of the sentence. Each predicate has the patient as the subject and links the subject to the objects associated with that predicate. Accordingly, subject-verb-object triplets, and similar patterns that the inventors have determined to represent a useful event mention, can easily be extracted from the tree 110 to express the meaning of the sentence. A potential event mention 116, indicating that the patient has been on corticosteroids, is circled in the diagram.

Returning to FIG. 3, the indexing system 70 further includes a pattern matching component 120 configured to search for a small defined set of patterns within the resulting semantic tree. Each identified pattern represents an event mention. In the illustrated implementation, a set of approximately twenty patterns has been defined by the inventors for use in identifying event mentions. Table 1 lists the patterns identified by the pattern matching component:

TABLE 1

(v:V

(+−> NSUBJ −> (s:T))
(!−> AUXPASS −> (A))
(?−> DOBJ −> (c:T)))

(v:V

(+−> NSUBJ −> (s:T))
(!−> AUXPASS −> (A))
(+−> C_POSSOBJ −> (c:T
(+−> POSSESSIVE −> (c′:POS)))))

(v:V

(+−> C_POSSSUBJ −> (s:T

(+−> POSSESSIVE −> (s′:POS))
(!−> AUXPASS −> (A))
(?−> DOBJ −> (c:T)))))

(v:V

(+−> DOBJ −> (c:T))
(!−> NSUBJ −> (A))
(!−> AUXPASS −> (A)))

(V

(+−> NSUBJ −> (s:T))
(+−> PREP|ADVMOD −> (IN

(!−> C_POSSOBJ −> (N))
(+−> PCOMP −> (v:VBG

(?−> DOBJ −> (c:T))
(!−> NSUBJ −> (A)))))))

(V

(+−> NSUBJ −> (s:T))
(!−> AUXPASS −> (A))
(!−> C_POSSOBJ −> (N))
(+−> XCOMP|PARTMOD −> (v:VBG

(!−> NSUBJ −> (A))
(?−> DOBJ −> (c:T)))))

(V

(+−> NSUBJ −> (s:T))
(!−> DOBJ −> (T))
(!−> AUXPASS −> (A))
(+−> C_POSSOBJ −> (s:N))
(+−> XCOMP|PCOMP|PARTMOD −> (v:VBG

(!−> NSUBJ −> (A))
(?−> DOBJ −> (c:T)))))

(V

(+−> NSUBJ −> (s:T))
(+−> DOBJ −> (c:T))
(+−> XCOMP|PARTMOD −> (v:VBG

(!−> NSUBJ|DOBJ −> (T))
(+−> DOBJ|ADVMOD −> (J)))))

(s:T

(+−> RCMOD −> (v:V

(+−> NSUBJ −> (WDT))
(?−> DOBJ −> (c:T)))))

(s:T

(+−> PARTMOD −> (v:VBG
(?−> DOBJ|POBJ −> (c:T)))))

(v:V

(+−> NSUBJ −> (s:T))
(!−> DOBJ −> (A))
(!−> AUXPASS −> (A))
(+−> XCOMP|PCOMP −> (c:V

(!−> NSUBJ|MARK −> (A)))))

(v:V

(+−> NSUBJ −> (s:T))
(!−> DOBJ −> (A))
(!−> AUXPASS −> (A))
(!−> C_POSSOBJ −> (N))
(+−> XCOMP −> (v:V

(!−> NSUBJ −> (A))
(+−> DOBJ −> (c:T)))))

(v:V

(+−> NSUBJ −> (c:T))
(+−> AUXPASS −> (V/isBeOrGet))
(?−> PREP −> (IN/isBy

(+−> POBJ −> (s:T)))))

(VBG|J

(+−> NSUBJ −> (c:T))
(+−> XCOMP −> (c:V

(+−> AUXPASS −> (V/isBeOrGet))
(?−> PREP −> (IN/isBy

(+−> POBJ −> (s:T)))))))

(c:N

(+−> PARTMOD −> (v:VBN

?−> PREP −> (IN/isBy

(+−> POBJ) −> s:T))))

(s:T

(+−> RCMOD −> (v:VBD

(+−> NSUBJ −> (s:T))
(!−> DOBJ −> (A)))))

(s:T

(+−> AMOD −> (JJ

(+−> XCOMP −> (v:VB

(+−> DOBJ −> (c:T)))))))

(V

(+−> NSUBJ −> (c:T))
(+−> CCOMP|ADVCL|NSUBJ −> (JJ

(+−> XCOMP −> (v:VB

(+−> AUX −> (TO))
(!−> AUXPASS −> (V/isBeOrGet))
(?−> DOBJ −> (c:T)))))))

(V

(+−> NSUBJ −> (c:T))
(+−> CCOMP|ADVCL|NSUBJ −> (JJ

(+−> XCOMP −> (v:VBN

(+−> AUX −> (TO))
(+−> AUXPASS −> (V/isBeOrGet))
(?−> PREP −> (IN/isBy

(+−> POBJ −> (s:T)))))))))

(V

(+−> NSUBJ −> (s:T))
(+−> PARTMOD −> (VBG

(+−> XCOMP −> (v:VB

(+−> AUX −> (TO))
(!−> AUXPASS −> (V/isBeOrGet))
(?−> PREP −> (c:T)))))))

(V

(+−> NSUBJ −> (c:T))
(+−> PARTMOD −> (VBG

(+−> XCOMP −> (v:VBN

(+−> AUX −> (TO))
(+−> AUXPASS −> (V/isBeOrGet))
(?−> PREP −> (IN/isBy

(+−> POBJ −> (s:T)))))))))

(c:J|N|CD

(+−> NSUBJ −> (s:T))
(+−> COP −> (v:V)))

(c:J|N|CD

(+−> DEP −> (s:T

(+−> COP −> (v:V))
(!−> NSUBJ −> (A)))))

(v:V

(+−> ACOMP −> (c:J

(+−> NSUBJ −> (s:T)))))

(v:V

(+−> NSUBJ −> (s:T))
(+−> XCOMP −> (c:J|N|CD

(+−> COP −> (V)))))

(v:V

(+−> NSUBJ −> (s:T))
(+−> ACOMP −> (c:J)))

In the table, a pattern is shown as a root node plus zero or more child branches, each of which contains another node that may optionally serve as the root of a subpattern. A child branch is indicated by one of the branch weight symbols +->, ?->, or !->, meaning the branch respectively must, may, or must not match a corresponding branch in the target graph in order for the entire pattern to match. Following the branch weight symbol is a parenthesized sequence of one or more names, delimited by | symbols, that indicate the grammatical dependency types the branch may match in the target. The grammatical dependency names are defined in the April 2015 revision of the Stanford Typed Dependencies Manual, by Marie-Catherine de Marneffe and Christopher D. Manning, which is herein incorporated by reference, with the addition the DEP matches any dependency at all and C_POSSOBJ and C_POSSSUBJ match special object and subject dependencies, respectively, introduced by the coreference replacement 98.

Each pattern node is represented by an optional label, a |-delimited sequence of names that indicate the parts of speech the node may match in the target graph, and an optional /-delimited sequence of predicate functions of target graph nodes that further gate matching. Part-of-speech names are as defined in the Penn TreeBank project (available at http://www.ling.upenn.edu/courses/Fall_2003/ling001/penn_treebank_pos.html) with the addition that V, N, J, T, and A respectively match any verb, any noun, any adjective, any “thing” (noun or pronoun), or any word at all. The predicate functions isBy and isBeOrGet respectively return true if their argument nodes are respectively the word “by” and any form of the words “be” or “get”. Pattern node labels may be s, v, or c or primed versions of these. When a pattern is found to match an event mention structure (i.e., a subgraph) in the target graph, then any target graph nodes corresponding to pattern nodes labeled s, v, or c are identified respectively as the subject, verb, or complement of the event mention. Any target graph nodes corresponding to primed labels are combined with those corresponding to their unprimed counterparts to form a composite subject, verb, or complement.

It will be appreciated that the list of patterns in Table 1 is nonexhaustive and that other patterns can be used in identifying event mentions. It is believed, however, that the size of a complete practical set of patterns is unlikely to significantly exceed the one in Table 1. Each identified event mention is a short text squib that describes some detail or note the occurrence of a larger event. This text can be augmented with a time, date, or geographic location at a context augmentation component 122. The context augmentation component 122 can extract time and location data from the text (e.g., the sentence from which the event mention was extracted) or metadata associated with the text and associated the event mention with the extracted time and/or location.

Extraction of event mentions can be used to create a number of novel utilities. For example, event mentions can be indexed and used to power an event based search system in which the user searches for event mentions or events rather than keywords. In the system illustrated in FIG. 3, however, event mentions can be further processed and grouped at an event identifier 130. It will be appreciated that the event mentions can be processed for a single document or across multiple documents. Various aspects of the event mentions can be used to group them together such as the time, the date and the location associated with the event mention. The content of the event mention can also be used to differentiate event mentions, such as differentiating “police shoot protester” and “man catches giant fish” according to their different subjects, objects, and predicates. This process can also use other metadata extracted from the original source documents. Once the values for the attributes have been defined, the event mentions can be clustered, with event mentions within a threshold distance of one another selected to define an event. The use of multiple event mentions within each event allows for a richer more complete description of each event. Moreover, the seriousness or importance of an event can be inferred by the number of event mentions associated with the event.

Events can also be processed across documents to form larger narrative strings at a narrative generator 134 in a manner similar to the process of joining multiple event mentions to form events. In this case, various attributes about each event can be used to group the events in a narrative string. For example, a single document may contain event mentions concerning two or more events, thus suggesting that these events may be related. Further, a common location, date, and time of events can suggest that they belong to a given narrative. By linking together multiple related events, these narrative strings provide greater background detail about the events in question. The resulting event mentions, events, and narratives can be added to an index allowing for reference to the documents via their semantic content.

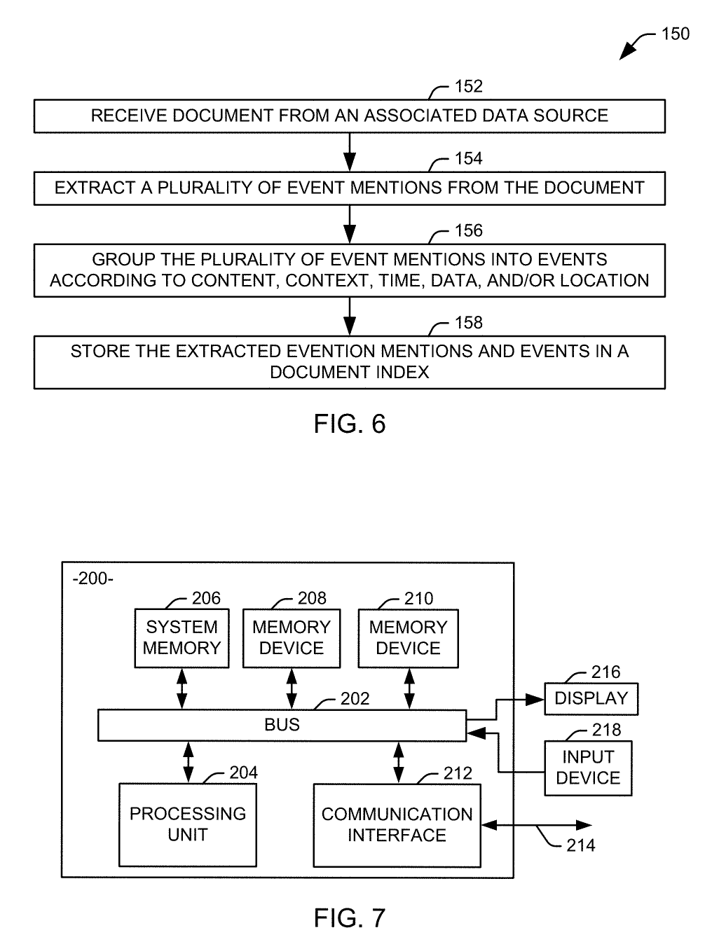

In view of the foregoing structural and functional features described above, methodologies will be better appreciated with reference to FIG. 6. It is to be understood and appreciated that the illustrated actions, in other embodiments, may occur in different orders and/or concurrently with other actions. Moreover, not all illustrated features may be required to implement a method.

FIG. 6 illustrates one example of a method 150 for indexing a document according to identified events. At 152, the document is received from an associated data source. At 154, a plurality of event mentions are extracted from the document, with a given event mention comprising a verb and at least one of a subject and an object of the verb. In one implementation, a dependency tree is created for each sentence of the document, in which one word is the root of the tree and all other syntactic units of the sentence are either directly or indirectly dependent on that word, from grammatical relationships between the words in the sentence. Semantically irrelevant material can be eliminated from the dependency tree to provide a graph having a same semantic content as the dependency tree, and event mentions can be extracted from the dependency tree according to a set of predetermined patterns of parts of speech.

At 156, the plurality of event mentions are grouped according at least one of their content, associated context, and an associated time, date, and location to provide at least one event. In one implementation, the grouping can be performed in a similar manner across documents to combine events into narratives. At 158, the extracted event mentions and the at least one event are stored in a document index such that a given document from an associated document corpus can be retrieved according to its associated event mentions and at leave one event. This can be used to facilitate an event-based search function for the documents or to facilitate use of the documents by various expert systems, such as decision support systems, performing analyses on the document corpus.

FIG. 7 is a schematic block diagram illustrating an exemplary system 200 of hardware components capable of implementing examples of the systems and methods disclosed in FIGS. 1-6. The system 200 can include various systems and subsystems. The system 200 can be a personal computer, a laptop computer, a workstation, a computer system, an appliance, an application-specific integrated circuit (ASIC), a server, a server blade center, a server farm, etc.

The system 200 can includes a system bus 202, a processing unit 204, a system memory 206, memory devices 208 and 210, a communication interface 212 (e.g., a network interface), a communication link 214, a display 216 (e.g., a video screen), and an input device 218 (e.g., a keyboard and/or a mouse). The system bus 202 can be in communication with the processing unit 204 and the system memory 206. The additional memory devices 208 and 210, such as a hard disk drive, server, stand-alone database, or other non-volatile memory, can also be in communication with the system bus 202. The system bus 202 interconnects the processing unit 204, the memory devices 206-210, the communication interface 212, the display 216, and the input device 218. In some examples, the system bus 202 also interconnects an additional port (not shown), such as a universal serial bus (USB) port.

The processing unit 204 can be a computing device and can include an application-specific integrated circuit (ASIC). The processing unit 204 executes a set of instructions to implement the operations of examples disclosed herein. The processing unit can include a processing core.

The additional memory devices 206, 208 and 210 can store data, programs, instructions, database queries in text or compiled form, and any other information that can be needed to operate a computer. The memories 206, 208 and 210 can be implemented as computer-readable media (integrated or removable) such as a memory card, disk drive, compact disk (CD), or server accessible over a network. In certain examples, the memories 206, 208 and 210 can comprise text, images, video, and/or audio, portions of which can be available in formats comprehensible to human beings.

Additionally or alternatively, the system 200 can access an external data source or query source through the communication interface 212, which can communicate with the system bus 202 and the communication link 214.

In operation, the system 200 can be used to implement one or more parts of an event indexing system in accordance with the present invention. Computer executable logic for implementing the system resides on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein refers to a medium that participates in providing instructions to the processing unit 204 for execution, and can include either a single medium or multiple non-transitory media operatively connected to the processing unit 204.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the scope of the appended claims.

1. A system comprising:
a data source;
an event-based indexing system, implemented as machine executable instructions on a non-transitory computer readable medium, for indexing a document according to identified events, comprising:
a source interface configured to receive the document from the data source and format the document for processing; and
an indexer configured to extract event mentions from the document, with a given event mention comprising a verb and at least one of a subject and an object of the verb, the indexer comprising:
a grammatical dependency parser configured to identify grammatical relationships between words in a given sentence of the document and create a dependency tree in which one word is the root of the tree and all other syntactic units of the sentence are either directly or indirectly dependent on that word; and
a grammar transformation component configured to eliminate semantically irrelevant material from the dependency tree and provide a graph having a same semantic content as the dependency tree; and
a document index implemented on a non-transitory computer readable medium and configured to store the extracted event mentions such that a given document from an associated document corpus can be retrieved according to its associated event mentions.

2. The system of claim 1, further comprising an event identifier configured to group the event mentions according at least one of their content, associated context, and an associated time, date, and location to provide an event and provide the event to the document index.

3. The system of claim 1, the grammar transformation component comprising an inversion of object quantifier phrases component configured to applying hypernym relationships from a lexical database to identify applicable quantifier phrases within the dependency tree and invert the quantifier phrases to make the objects of the quantifier phrases depend on the governing verbs.

4. The system of claim 1, the grammar transformation component comprising a named entity identifier configured to identify named entities from an associated database and tag them.

5. The system of claim 1, the grammar transformation component comprising an intransitive-to-transitive verb conversion configured to transforms a phrase comprising an intransitive verb, one or more prepositions, and a prepositional object into a phrase comprising a compound transitive verb with a direct object.

6. The system of claim 1, the grammar transformation component comprising a phrasal verbs conversion configured to transform a phrase comprising either of a verb and particle or a verb and proposition into a verb.

7. The system of claim 1, the grammar transformation component comprising a conjunctions and disjunctions expansion configured to expand compound phrases, combined via one of a conjunction or a disjunction, into multiple distinct phrases.

8. The system of claim 1, the indexer further comprising a pattern matching component configured to search the dependency tree for any of a small defined set of patterns of parts of speech within the semantic tree, with each identified pattern represents an event mention.

9. The system of claim 1, the indexer comprising a context augmentation component configured to extract time and location data from one of the document and metadata associated with the document and associate the event mention with the extracted time and location data.

10. A computer-implemented method for indexing a document according to identified events, comprising:
receiving the document from an associated data source;
extracting a plurality of event mentions from the document, a given event mention comprising a verb and at least one of a subject and an object of the verb;
grouping the plurality of event mentions according at least one of their content, associated context, and an associated time, date, and location to provide at least one event; and
storing the extracted event mentions and the at least one event on a non-transitory computer readable medium such that a given document from an associated document corpus can be retrieved according to its associated event mentions and at least one event.

11. The method of claim 10, wherein extracting the plurality of event mentions from the document comprises creating a dependency tree for each sentence of the document, in which one word is the root of the tree and all other syntactic units of the sentence are either directly or indirectly dependent on that word, from grammatical relationships among the words in the sentence.

12. The method of claim 11, wherein extracting the plurality of event mentions from the document comprises eliminating semantically irrelevant material from the dependency tree to provide a graph having a same semantic content as the dependency tree.

13. The method of claim 12, wherein eliminating semantically irrelevant material from the dependency tree comprises applying hypernym relationships from a lexical database to identify applicable quantifier phrases within the dependency tree and invert the quantifier phrases to make the objects of the quantifier phrases depend on the governing verbs.

14. The method of claim 12, wherein eliminating semantically irrelevant material from the dependency tree comprises replacing pronouns and other coreference mentions within the dependency tree with explicit referents.

15. The method of claim 12, wherein eliminating semantically irrelevant material from the dependency tree comprises combining intransitive verbs and simple adjectival complements within the dependency tree into compound verbs.

16. A system comprising:
a data source;
an event-based indexing system, implemented as machine executable instructions on a non-transitory computer readable medium, for indexing a document according to identified events, comprising:
a source interface configured to receive the document from the data source and format the document for processing; and
an indexer configured to extract event mentions from the document, with a given event mention comprising a verb and at least one of a subject and an object of the verb, the indexer comprising:
a part of speech tagger configured to assign a part of speech to each word within the document;
a grammatical dependency parser configured to identify grammatical relationships between words in a given sentence of the document and create a dependency tree in which one word is the root of the tree and all other syntactic units of the sentence are either directly or indirectly dependent on that word; and
a grammar transformation component configured to eliminate semantically irrelevant material from the dependency tree and provide a graph having a same semantic content as the dependency tree; and
a document index implemented on a non-transitory computer readable medium and configured to store the extracted event mentions such that a given document from an associated document corpus can be retrieved according to its associated event mentions.

17. The system of claim 16, the grammar transformation component comprising a named entity identifier configured to identify named entities from an associated database and tag them.

18. The system of claim 16, the grammar transformation component comprising a possessive noun adjustment component configured to replace a subject or object dependency relationship to the base of a possessive noun with a possessive version of the subject or object dependency to prevent the base noun from being misidentified as a subject or object.

19. The system of claim 16, the indexer further comprising a context augmentation component configured to extract time and location data from one of the document and metadata associated with the document and associate the event mention with the extracted time and location data.

20. The system of claim 19, further comprising an event identifier configured to group the event mentions according at least one of their content, associated context, and the extracted time and location data to provide an event and provide the event to the document index.
